(19) United States
(12) Patent Application Publication
(10) Pub. No.: US 2013/0137309 A1
(43) Pub. Date: May 30, 2013

(54) MICRO-CONNECTOR WITH FLATLY DISPOSED PINS

(71) Applicant: Peng-Fei Lin, Hsinchu (TW)

(72) Inventor: Peng-Fei Lin, Hsinchu (TW)

(21) Appl. No.: 13/351,213

(22) Filed: Jan. 16, 2012

(30) Foreign Application Priority Data
Nov. 24, 2011 (TW) 100143183

(51) Int. Cl. H01R 24/28

(52) U.S. Cl. 439/660

(57) ABSTRACT

A micro-connector with flatly disposed pins is provided, including a plug unit and a metal shell. The plug unit includes an insulation element, a plug, and a plurality of pins, wherein the plug and a plurality of pins are disposed on opposite sides of the insulation element. The metal ends of the pins penetrate through the inside of the insulation element to extend into the plug for electrical connection. The metal shell is engaged to the insulation element, with extending positioning pins. The insertion direction of the positioning pins forms an angle with the insertion direction of the plug. The angle is preferably between 45°-135° so as to enable easy assembly and good fastening result.

### FIELD OF THE INVENTION

The present invention generally relates to a micro-connector, and more specifically to a plug-type micro-connector, easier for manufacturing and assembly, and having a stronger hold when in use.

### BACKGROUND OF THE INVENTION

Conventional electronic connectors can be roughly categorized as plug-type connector or socket-type connector. A plug-type connector is usually connected to a wire directly. For assembly, the pins on a side of the plug-type connector are soldered to the metal wire. Finally, a hard-shell plastic and insulation material are used to seal and shape. Therefore, this type of connector mostly has a flat or column-like shape to enable the endurance of multiple plugging-and-unplugging without disassembled.

As the development of new products, the plug-type connector may be disposed on a side of a product with only the plug part exposed. Therefore, the conventional protection from hard plastic shell is no longer an option. In addition, as the repetitive plugging and unplugging increases, the endurance of the plug-type connector becomes a central design issue. The new assembly technique used in products indicates that the plug-type connector may face a challenge from the conventional design. It is imperative devise a new structure for the plug-type connector with easy manufacturing and assembly as well as high endurance capability for new applications.

### SUMMARY OF THE INVENTION

The primary object of the present invention is to provide a micro-connector with flatly disposed pins aligned in parallel with the micro-connector to enable a flat attachment to a printed circuit board (PCB). The micro-connector is a plug-type connector convenient for assembly and enhances the endurance for repetitive plugging and unplugging.

To achieve the above object, the present invention provides a micro-connector, including a plug unit and a metal shell. The plug unit includes an insulation element, a plug, and a plurality of pins, wherein the plug and a plurality of pins are disposed on opposite sides of the insulation element. The metal ends of the pins penetrate through the inside of the insulation element to extend into the plug for electrical connection. The metal shell is engaged to the insulation element, with extending positioning pins. The insertion direction of the positioning pins forms an angle with the insertion direction of the plug. The angle is preferably between 45°-135° so as to enable easy assembly and good fastening result.

The main feature of the present invention is the positioning pins extending downwards from the metal shell so that the micro-connector can be easily fixed to a PCB for convenient subsequent wire soldering operation. Because the insertion direction of the positioning pins is not parallel to the insertion direction of the plug, the strength of the engagement between the micro-connector and the PCB is enhanced after assembly so as to endure the repetitive plugging and unplugging.

In addition, the exposed pins of the plug unit ate at the same height level. When installed to PCB, the pins can be attached to the solder pad on PCB in a flat manner to accomplish electrical connection for convenient subsequent soldering operations.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the present invention;

FIG. 2 shows a side view of the present invention; and

FIG. 3 shows a dissection view of the present invention applied to a PCB.

### DETAILED DESCRIPTION OF THE PREFERRED EMBODIMENTS

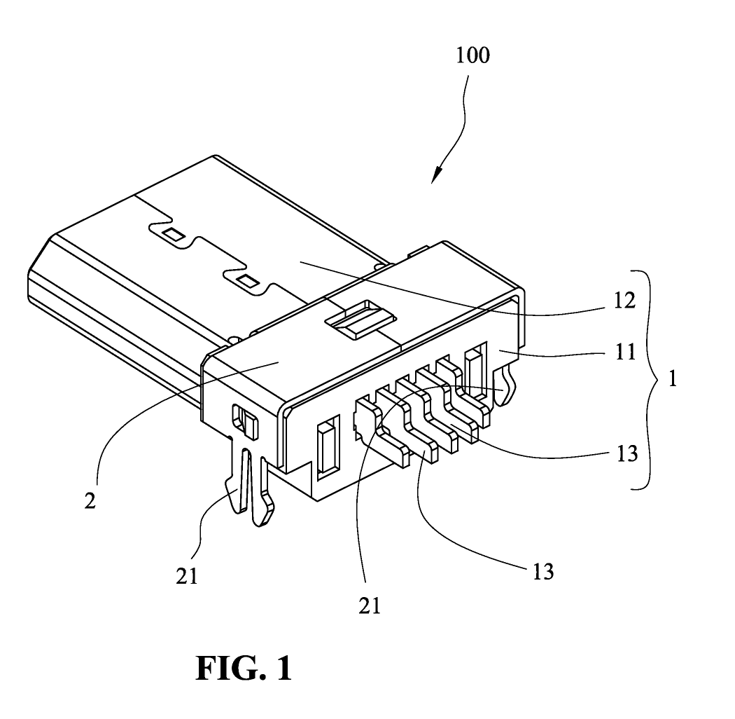

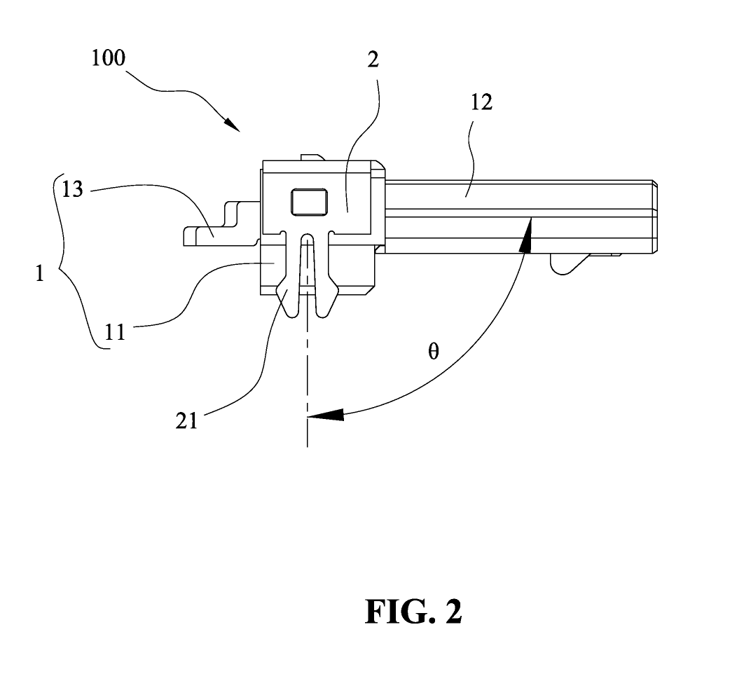

FIG. 1 and FIG. 2 show a schematic view and a side view of the present invention, respectively. A micro-connector 100 with flatly disposed pins is a plug-type micro-USB connector to install on a PCB, including a plug unit 1 and a metal shell 2. Metal shell 2 is engaged to plug unit 1 so that micro-connector 100 is convenient for assembly and can provide good fastening effect after installed.

The following describes the components of the present invention in details. Plug unit 1 is a basic plug-type micro-USB connector, including an insulation element 11, a plug 12 fixed to one side of insulation element 11, and a plurality of pins 13 extending from inside of insulation element 11. The type and shape of plug 12 matches the specification of current micro-USB plug. Pins 13 have metal pins penetrating from inside of insulation element 11 into plug 12 for electrical connection. In the present embodiment, pins 13 are exposed and disposed at the same height level so that pins are flatly disposed on the PCB during assembly to enable convenient subsequent soldering operations. In addition, insulation element 11 has a smaller form at the part under pins 13 for positioning on the PCB.

Metal shell 2 is engaged to insulation element 11, with extending at least a positioning pin 21 to fasten to the PCB. The present embodiment shows two positioning pins 21, located on the opposite wider sides of insulation element 11. Positioning pin 21 can be of any shape. In the present embodiment, the shape of positioning pin 21 is a two-piece hook for stronger hold for fastening. As shown in FIG. 2, the insertion direction of positioning in 21 forms an angle θ with the insertion direction of plug 12, where θ is between 45°-135°, and preferably 80°-100°. In the present embodiment, θ is set at 90°. The object of forming an angle is to enhance the holding strength after assemble so as to endure the repetitive plunging and unplugging.

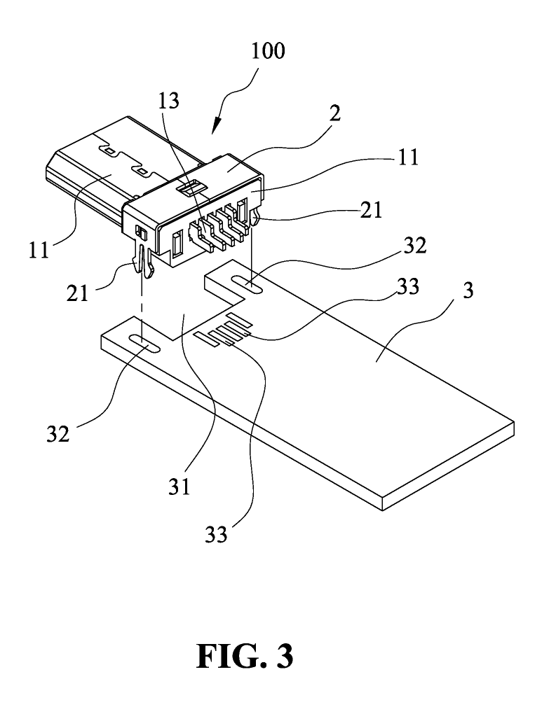

FIG. 3 shows a dissection view of micro-connector 100 of the present invention applied to a PCB. In addition to basic circuits and electronic components (not shown in FIG. 3), PCB 3 further includes a gap 31, at least a positioning hole 32 and a plurality of solder pads 33. Gap 31 has a shape matching the shape of insulation element 11. Positioning holes 32 are located correspondingly to match positioning pins 21. A plurality of solder pads 33 is located correspondingly to match a plurality of pins 13. For assembly, micro-connector 100 is placed onto PCB 3 from above, with positioning pins 21 inserted into positioning holes 32 to fasten the relative position between micro-connector 100 and PCB 3. Because of gap 31, pins 13 lie flatly upon solder pads 33 of PCB 3 to form contact for electrical connection, as well as enable convenient subsequent soldering operation.

In summary, the present invention provides a micro-connector having a metal shell to engage at the plug unit, and positioning pins extending from metal shell and perpendicular to the insertion direction of the plug to enable convenient assembly of the micro-connector as well as enhancing the holding strength to endure repetitive plugging and unplugging.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A micro-connector with flatly disposed pins, said micro-connector comprising a plug unit and a metal shell;
wherein said plug unit having an insulation element, a plug, and a plurality of pins, with said plug and said plurality of pins disposed on opposite sides of said insulation element; metal ends of said pins penetrating through inside of said insulation element to extend into said plug for electrical connection; and
said metal shell engaged to said insulation element, with extending at least a positioning pin, insertion direction of said positioning pin forming an angle with insertion direction of said plug, said angle being between 45°-135°.

2. The micro-connector as claimed in claim 1, wherein said angle formed between said insertion direction of said positioning pin and said insertion direction of said plug is preferably between 80°-100°.

3. The micro-connector as claimed in claim 1, wherein said insertion direction of said positioning pin is perpendicular to said insertion direction of said plug

4. The micro-connector as claimed in claim 1, wherein said positioning pin is two-piece hook.

5. The micro-connector as claimed in claim 1, wherein said plurality of pins exposed outside of said plug unit are at the same height level.
